(19) United States
(12) Patent Application Publication
(10) Pub. No.: US 2006/0244733 A1
(43) Pub. Date: Nov. 2, 2006

(54) Touch sensitive device and method using pre-touch information

(76) Inventor: Bernard O. Geaghan, Salem, NH (US)

Correspondence Address: 3M INNOVATIVE PROPERTIES COMPANY, PO BOX 33427, ST. PAUL, MN, 55133-3427, US

(21) Appl. No.: 11/116,576

(22) Filed: Apr. 28, 2005

(51) Int. Cl. G09G 5/00

(52) U.S. Cl. 345/173

(57) ABSTRACT

A touch device uses pre-touch sensing to enhance touch location determination and/or to activate various processes. Pre-touch signals are generated by one or more pre-touch sensors responsive to a touch implement hovering above the touch surface. The pre-touch signals indicate a pre-touch location of the touch implement. One or more touch sensors generate touch signals responsive to a touch by the touch implement on the touch surface. The touch signals indicate a touch location of the touch implement. A controller determines a touch location based on the pre-touch signals and the touch signals. Activation and/or deactivation of various processes may be triggered based on information acquired from the pre-touch and/or touch sensors.

### FIELD OF THE INVENTION

The present invention relates to touch sensitive devices and, more particularly, to methods and systems for touch processes that acquire and use pre-touch information.

### BACKGROUND

A touch sensitive device offers a simple, intuitive interface to a computer or other data processing device. Rather than using a keyboard to type in data, a user can transfer information by touching an icon or by writing or drawing on a touch sensitive panel. Touch panels are used in a variety of information processing applications. Interactive visual displays often include some form of touch sensitive panel. Integrating touch sensitive panels with visual displays is becoming more common with the emergence of next generation portable multimedia devices such as cell phones, personal data assistants (PDAs), and handheld or laptop computers.

Various methods have been used to determine the location of a touch on a touch sensitive panel. Touch location may be determined, for example, using a number of force sensors coupled to the touch panel. The force sensors generate an electrical signal that changes in response to a touch. The relative magnitudes of the signals generated by the force sensors may be used to determine the touch location.

Capacitive touch location techniques involve sensing a current change due to capacitive coupling created by a touch on the touch panel. A small amount of voltage is applied to a touch panel at several locations, for example, at each of the touch panel corners. A touch on the touch panel couples in a capacitance that alters the current flowing from each corner. The capacitive touch system measures the currents and determines the touch location based on the relative magnitudes of the currents.

Resistive touch panels are typically multilayer devices having a flexible top layer and a rigid bottom layer separated by spacers. A conductive material or conductive array is disposed on the opposing surfaces of the top and bottom layers. A touch flexes the top layer causing contact between the opposing conductive surfaces. The system determines the touch location based on the change in the touch panel resistance caused by the contact.

Touch location determination may rely on optical or acoustic signals. Infrared techniques used in touch panels typically utilize a specialized bezel that emits beams of infrared light along the horizontal and vertical axes. Sensors detect a touch that breaks the infrared beams.

Surface Acoustic Wave (SAW) touch location processes use high frequency waves propagating on the surface of a glass screen. Attenuation of the waves resulting from contact of a finger with the glass screen surface is used to detect touch location. SAW typically employs a “time-of-flight” technique, where the time for the disturbance to reach the pickup sensors is used to detect the touch location. Such an approach is possible when the medium behaves in a non-dispersive manner, such that the velocity of the waves does not vary significantly over the frequency range of interest.

Bending wave touch technology senses vibrations created by a touch in the bulk material of the touch sensitive substrate. These vibrations are denoted bending waves and may be detected using bending mode sensors typically placed on the edges of the substrate. Signals generated by the sensors are analyzed to determine the touch location. In some implementations, the sensor signals may be processed to account for frequency dispersion caused by the substrate material.

Some of the above touch technologies are capable of detecting the proximity of a user's finger or other touch implement as it hovers above the touch surface. For any of the technologies outlined above, increasing the accuracy and/or speed of touch location determination and decreasing the processing and/or cost of the implementation is desirable. The present invention fulfils these and other needs, and offers other advantages over the prior art.

### SUMMARY OF THE INVENTION

The present invention is directed to methods and systems for using pre-touch information to enhance touch location determination and/or to activate various processes. An embodiment of the invention involves a touch sensing method. Pre-touch signals are generated responsive to a presence of a touch implement above a touch surface. Touch signals are generated responsive to a touch on the touch surface. The location of a touch on the touch surface is determined based on the touch signals and the pre-touch signals.

In accordance with one aspect of the invention, the pre-touch location of the touch implement relative to the touch surface is determined. Determining the pre-touch location may involve determining x and y-axis coordinates of the pre-touch location relative to a plane of the touch surface. A Z-axis component of at least one of the pre-touch location and the touch location may be determined. Determining the Z-axis component may involve measuring a distance of the touch implement from the touch surface or measuring a touch force.

In accordance with another aspect of the invention, a touch is detected on the touch surface if the touch implement is sufficiently close to the touch surface, for example, closer than a predetermined distance or is producing a force on the touch surface, for example, larger than a predetermined force.

In one implementation, the pre-touch signals may be generated using one or more of a first type of sensor and the touch signals may be generated using one or more of a second type of sensor. In another implementation, the one or more pre-touch sensors and the one or more touch sensors may be the same type of sensor. A first process, such as moving a cursor or selecting a menu item, may be activated based on the pre-touch sensor signals. A second process, such as activating a process associated with the menu item, may be performed based on the touch signals. For example, the touch sensing and/or touch location circuitry may be activated based on the pre-touch signals. The pre-touch sensing and/or pre-touch location circuitry may be deactivated based on the touch signals.

Another embodiment of the invention involves a touch sensitive device. The touch sensitive device includes a touch surface. A pre-touch sensor generates pre-touch signals responsive to a touch implement above the touch surface. The pre-touch signals are indicative of a pre-touch location of the touch implement. A touch sensor generates touch signals responsive to a touch by the touch implement on the touch surface. The touch signals are indicative of a touch location of the touch implement. The touch sensitive device includes a controller configured to determine the touch location based on the pre-touch signals and the touch signals.

In accordance with an aspect of the invention, the touch sensitive device may further include a display visible through the touch surface. A host computing system may be coupled to the display and the controller. The host computing system may be configured to control the display based on a touch state.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1A is a flowchart illustrating a method of determining touch location using touch signals and pre-touch signals in accordance with embodiments of the invention;

FIG. 1B is a flowchart illustrating a method of determining touch location using a first sensor type or touch location methodology to generate pre-touch signals and using a second sensor type or touch location methodology to generate touch signals in accordance with embodiments of the invention;

FIG. 2A is a block diagram of a touch sensing system that uses pre-touch signals and touch signals for touch location determination in accordance with embodiments of the invention;

FIG. 2B illustrates a matrix capacitive touch sensor configured to generate pre-touch and touch signals to determine a touch location in accordance with embodiments of the invention;

FIG. 2C is a state diagram that conceptually illustrates the operation of a touch sensing system in accordance with embodiments of the invention;

FIG. 3A is a flowchart illustrating a method of using pre-touch information to confirm that a valid touch has occurred and to enhance touch location determination in accordance with embodiments of the invention;

FIG. 3B is a flowchart illustrating a method of detecting a touch based on measured Z-axis information and for determining touch location in accordance with embodiments of the invention;

FIG. 4 is a flowchart illustrating a method of activating touch location circuitry prior to the touch and deactivating touch location circuitry after the touch in accordance with embodiments of the invention;

FIG. 5 is a flowchart illustrating a method of deactivating pre-touch sensors after detecting a hovering touch implement and/or determining the pre-touch location in accordance with embodiments of the invention;

FIG. 6 is a flow chart illustrating activation of one or more of a first set of processes based on pre-touch information and activation of one or more of a second set of processes based on touch information in accordance with embodiments of the invention;

FIG. 7 is a block diagram illustrating a touch panel system suitable for utilizing pre-touch signals and determining touch location in accordance with embodiments of the invention; and

FIGS. 8A-8C show graphs of signal vs. time associated with two touch down events.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings that form a part hereof, and in which is shown by way of illustration, various embodiments in which the invention may be practiced. It is to be understood that the embodiments may be utilized and structural changes may be made without departing from the scope of the present invention.

Various types of touch sensors are capable of determining the proximity of a touch implement hovering over the surface of a touch sensitive panel. For example, hover detection and/or proximity measurement may be performed using capacitive touch sensors, infrared touch sensors, and/or optically sensitive liquid crystal displays (LCDs), among others. Embodiments of the invention are directed to the use of pre-touch information to provide enhanced touch sensing functionality. Pre-touch information may include, for example, hover detection, proximity measurement, and/or pre-touch location determination.

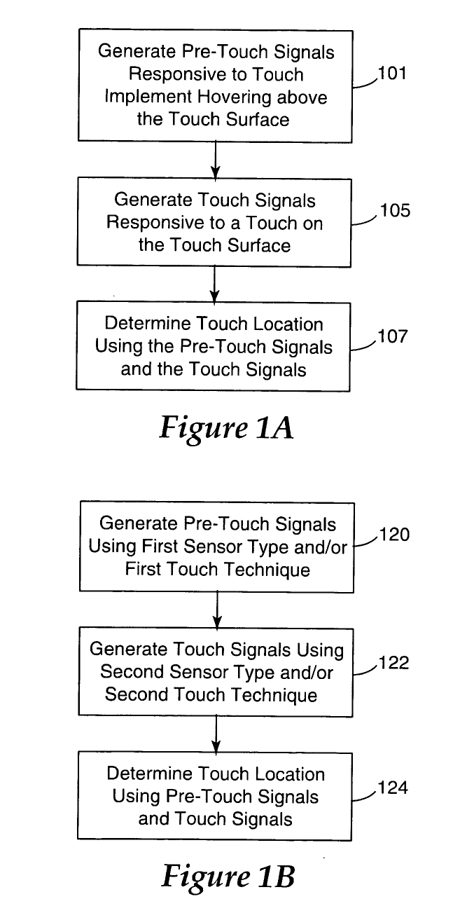

FIG. 1A is a flowchart illustrating a method of using pre-touch sensing to enhance touch location determination in accordance with embodiments of the invention. One or more pre-touch sensors are used to generate 101 pre-touch signals prior to a touch implement touching the panel. After touch down of the touch implement, one or more touch sensors generate 105 touch signals responsive to the touch on the touch panel. The location of the touch is determined 107 using both the touch signals and the pre-touch signals.

In various embodiments, pre-touch sensing may involve sensors and/or sensing methodologies of the same type or a different type from the touch sensing sensors and/or methodologies. This concept is illustrated by the flowchart of FIG. 1B. Pre-touch signals are generated 120 using a first sensor type and/or a first methodology. Touch signals are generated 122 using a second sensor type and/or a second methodology. The location of the touch is determined 124 using the pre-touch signals and the touch signals.

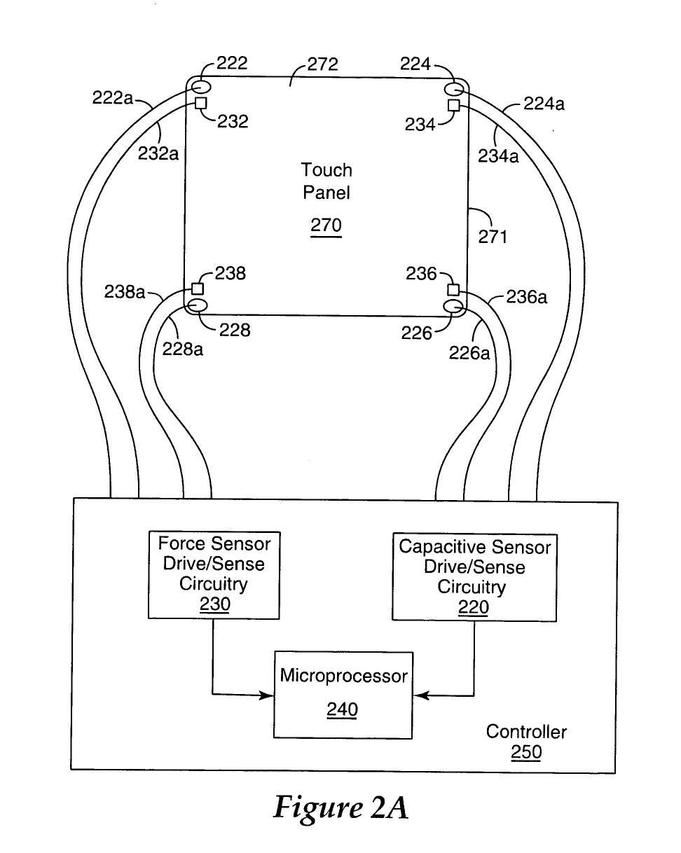

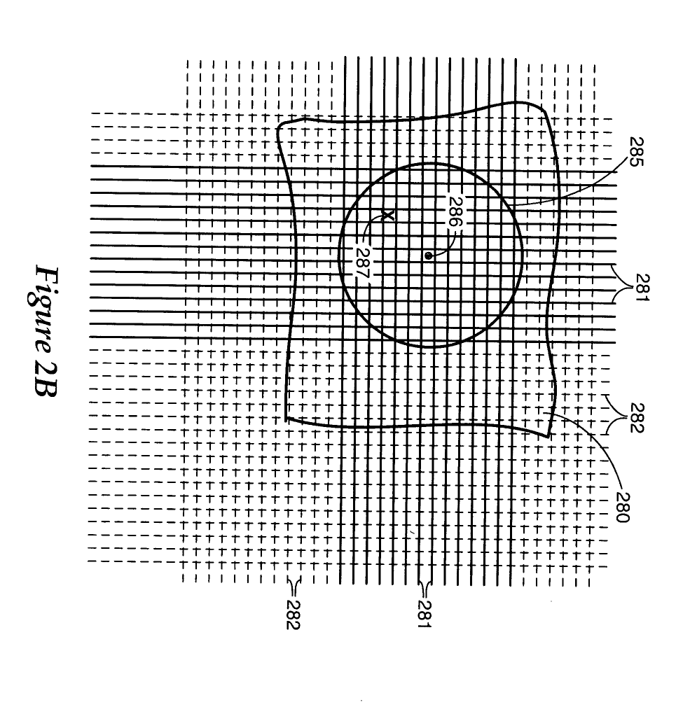

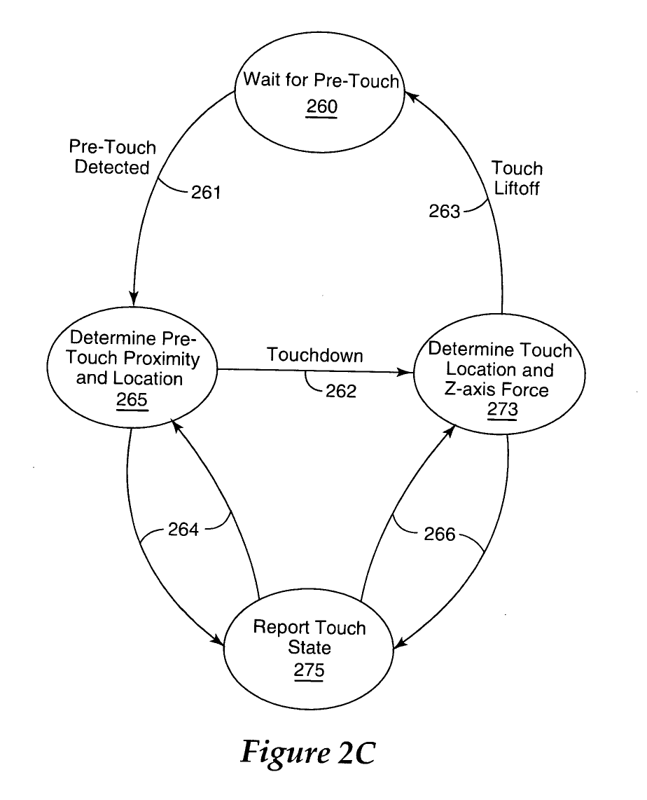

FIG. 2A illustrates a block diagram of a touch sensing system that is capable of sensing pre-touch and touch conditions and using pre-touch and touch information in accordance with embodiments of the invention. In this example, pre-touch sensing is accomplished using a capacitive sensor and touch sensing is accomplished using force sensors. FIG. 2A shows a touch sensing system that includes a capacitive touch panel 270 and also incorporating four force sensors 232, 234, 236, 238 arranged at the corners of the rectangular touch panel 270. The capacitive touch panel 270 and the force sensors 232, 234, 236, 238 are electrically coupled to a controller 250. The capacitive touch panel 270 includes a substrate, such as glass, which has top 272 and rear 271 surfaces respectively provided with an electrically conductive coating. The top surface 272 is the primary surface for sensing pre-touch and touch conditions. The top surface 272 is nominally driven with an AC voltage in the range of about 1 V to about 5 V.

The capacitive touch panel 270 is shown to include four corner terminals 222, 224, 226, 228 to which respective wires 222a, 224a, 226a, 228a are attached. Each of the wires 222a, 224a, 226a, 228a is coupled to the controller 250. The wires 222a, 224a, 226a, 228a connect their respective corner terminals 222, 224, 226, 228 to respective drive/sense circuits of the capacitive sensor drive/sense circuitry 220 provided in the controller 250.

The controller 250 controls the voltage at each of the corner terminals 222, 224, 226, 228 via capacitive sensor drive/sense circuitry 220 to maintain a desired voltage on the top surface 272. A finger or other touch implement hovering above the top surface 272 is detected as an effective small capacitor applied at the top surface 272. The hovering touch implement produces a change in current flow measurements made by the controller 250 via capacitive drive/sense circuitry 220. The controller 250 measures the changes in currents at each corner terminal 222, 224, 226, 228 caused by the change in capacitance. The controller 250 may use the capacitance change to detect hover, determine pre-touch location, and/or measure the proximity of the hovering touch implement from the top surface 272 based on the relative magnitudes of the corner currents. The Z-axis proximity of the hovering implement may be determined as a function of the change in current as the hovering implement approaches the top surface 272. Hover detection, i.e., the recognition that an implement is hovering above the top surface 272 may occur, for example, if the change in current exceeds a predetermined limit. The X,Y position of the pre-touch hover location may be determined using Equations 1 and 2 below.
XH=(UR+LR−UL−LL)/(UR+LR+UL+LL) Equation 1
YH=(UR+UL−LR−LL)/(UR+LR+UL+LL) Equation 2
where UL, LL, LR, UR are signal currents measured at the upper left, upper right, lower right, lower left corner terminals 222, 224, 226, 228, respectively.

The force sensors 232, 234, 236, 238 are used to determined the touch location after the touch implement comes in contact with the touch surface, an event referred to as touch down. The force sensors 232, 234, 236, 238 are located proximate to the rear surface 271 of the touch panel 270 at respective corners of the touch panel 270. As a stylus, finger or other touch implement presses the touch surface 272, a touch force is exerted upon the touch surface 272. The touch force acts on the force sensors 232, 234, 236, 238 in an amount that can be related to the location of the force application.

The forces on the force sensors 232, 234, 236, 238 cause a change in the signals generated by the force sensors 232, 234, 236, 238. The force sensors 232, 234, 236, 238 are coupled through wires 232a, 234a, 236a, 238a to force sensor drive/sense circuitry 230 in the controller 250. The controller 250 measures the changes in signals generated by each of the force sensors 232, 234, 236, 238 caused by the change in touch force. The controller 250 may use the signal changes to detect touch down, determine touch location, and/or measure the Z-axis force of the touch implement on the top surface 272. The Z-axis force of the touch implement on the touch surface 272 may be determined as a function of the sum of the forces as indicated by Equations 3 and 4 below. Touch down, i.e., the recognition that an implement has touched the touch panel 270 may occur, for example, if the total force, FTZ, exceeds a predetermined limit.

Calculation of the touch location may be performed, for example, using combinations of the force sensor signals. The signals generated by the force sensors 232, 234, 236, 238 may be used to calculate various touch-related signals, including the moment about the y-axis, M_{y}, moment about the x-axis, Mₓ, and the total Z-axis force, F_{Tz}. The coordinates of the touch location may be determined from the force sensor signals, as provided in Equations 3 and 4:
XT=(URF+LRF−ULF−LLF)/(URF+LRF+ULF+LLF) Equation 3
YT=(URF+ULF−LRF−LLF)/(URF+LRF+ULF+LLF) Equation 4

where XT and YT are force-based touch coordinates and URF, LRF, ULF, LLF are the forces measured by the upper right 234, lower right 236, upper left 232, lower left 238 sensors, respectively.

In one embodiment, the pre-touch location determined using the capacitive sensor may be used as a lower accuracy “coarse” touch location during the final touch location process. The coarse touch location may be used to simplify and/or accelerate the calculation of a more accurate “finer” touch location using the force sensors.

Lower accuracy during hover may have fewer detrimental consequences than lower touch location accuracy. Lower accuracy in hover location may be of less consequence because the user may not be performing any operations that require higher accuracy. For example, the user may be moving a cursor or cross-hair around based on the hover location. In this scenario, the consequences for lower accuracy during hover are minor. Further, because a displayed cursor may be tracking the hover movements, the user has visual confirmation of where the system has determined the hover position to be, and can adjust the position. An advantage of obtaining a location during hover, even if it is a low accuracy location, is that the hover location defines a relatively small region on a much larger touch surface where the touch is expected to land.

Detection of a touch down may be more reliably detected by a combination of two independent sensors and/or methods. Each method may have sources of error that are mitigated by the use of the other method. For example, analog capacitive touch systems may have difficulty resolving hover location in the presence of significant “hand shadow” whereby the hover location is influenced by capacitance from a finger in proximity, (desirable) and also by a hand in proximity to the touch surface, (undesirable, as it introduces an error in finger location measurement). When hand shadow is “strayed in”, it may introduce an error in capacitive measurements of touch down location. Force systems are not subject to hand shadow, so hand shadow-induced errors in capacitive measurement can be corrected by the force measurement at touch down.

The controller may use signals generated by the pre-touch sensors and/or the touch sensors to implement various processes in addition to determining touch location. For example, the controller 250 may activate and deactivate the touch location circuitry based on the pre-touch sensor signals. Deactivating touch location circuitry until it is needed conserves device power which may be particularly important for battery-powered portable devices.

An example of the use of pre-touch information to enhance touch location determination is illustrated by FIG. 2B. FIG. 2B conceptually illustrates a portion of a surface 280 of a matrix capacitive touch sensor. Matrix capacitive touch sensors include a grid of transparent, conductive material, such as indium tin oxide (ITO), or other suitable conductors. The controller (not shown) accesses each of the gridlines 281, 282 to determine if a change in capacitance has occurred. A change in capacitance indicates an impending or presently occurring touch.

In accordance with embodiments of the invention, the pre-touch information may be used, prior to touch down, to define an area 285 of the touch panel where the touch is likely to occur. In this embodiment, the hover location 286 is determined and an area 285 about the hover location 286 is computed. The controller then tests only the gridlines 281 that are associated with that area 285. The remaining gridlines 282 are not tested because the touch is not expected to occur at a location associated with these gridlines 282. In this example, the use of the pre-touch hover location speeds the touch location determination by reducing the amount of processing required to determine the touch location.

Another implementation illustrating the use of an initial coarse touch location to enhance touch location determination is described in commonly owned U.S. patent application Ser. No. 11/032,572, which is incorporated herein by reference. The referenced patent application describes an iterative method for deriving touch location. The concepts of the referenced patent application, as applied to the present invention, for example, may involve the use of the initial “coarse” location acquired using a capacitive pre-touch sensor, or other type of pre-touch sensor. Successive iterations of touch location may be implemented based on the information acquired from the pre-touch sensor signals.

Although the examples provided in FIGS. 2A and 2B illustrate examples of a capacitive sensor used for acquiring pre-touch information and capacitive or force sensors for acquiring touch information, various types of sensors may be used to acquire pre-touch information and touch information. Sensors used to sense pre-touch and/or touch conditions, may include, for example, various types of capacitive sensors, force sensors, surface acoustic wave (SAW) sensors, bending mode sensors, infrared sensors, optical LCDs, resistive sensors, and/or other touch sensor types.

For example, in various embodiments, capacitive sensors may be combined with force sensors, bending wave acoustic sensors, infrared (IR) sensors, resistive sensors, or force sensors to sense pre-touch and touch conditions. Capacitive or optical sensors may be used to provide pre-touch location coordinates and force, capacitive, SAW, IR or other sensors may be used to detect touch down and to measure more accurate touch location coordinates. Matrix capacitive sensors may detect proximity and measure a coarse position during hover. Optical methods, including optically sensitive LCDs may detect proximity and measure a coarse position during hover. Force sensors, resistive sensors, SAW sensors, or bending wave sensors, or other types of touch sensing systems, may be augmented with a capacitive or optical proximity sensor that detects the presence of a person within a predetermined range of the touch panel. The presence of the person may activate the display of an audiovisual program, or other processes, for example.

A touch sensing system that is capable of pre-touch sensing and touch sensing may be used to report the X and Y-axis coordinates of the pre-touch location, the X and Y-axis coordinates of the touch location, and/or Z-axis information ranging from measured proximity from the touch panel surface to measured touch force exerted on to the touch panel surface. FIG. 2C is a state diagram that conceptually illustrates the operation of a touch sensing system in accordance with embodiments of the invention. Prior to detecting a pre-touch condition (touch implement hovering above the touch surface) the touch sensing system remains in a wait state 260. After detecting the pre-touch condition, the system transitions 261 to a mode 265 wherein the system determines pre-touch proximity and may also determine pre-touch location. The system may periodically 264 update and report 275 the current touch state, including pre-touch proximity and/or pre-touch location to a host computer.

Touch down may be detected, for example, when the touch implement comes within a predetermined distance of the touch surface or exerts a predetermined amount of force on the touch surface or signals exceed a predetermined level. After touch down is detected, the system transitions 262 to a mode 273 wherein the system determines touch force and touch location. The system may periodically 266 update the current touch state, including touch force and touch location, and report 275 the current touch state to the host computer. Touch lift off may be detected, for example, when the touch force is less than a predetermined value or when the touch implement is beyond a predetermined distance from the touch surface. Following touch lift off, the system transitions 263 to the wait state 260.

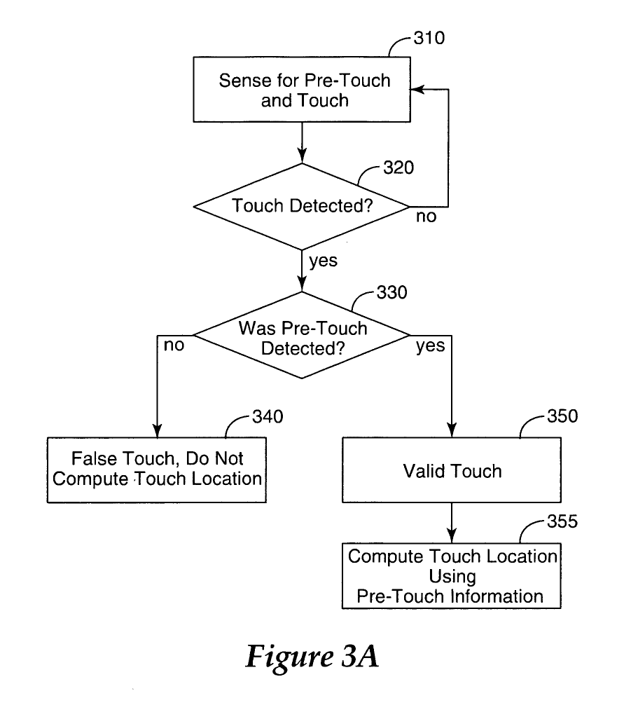

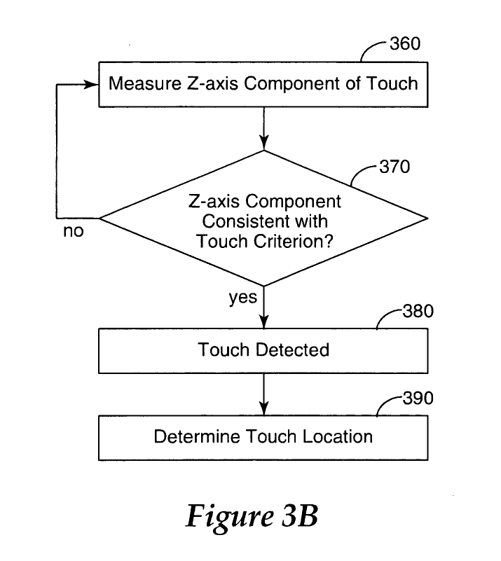

In some scenarios, a touch sensing device may erroneously detect a touch when none is present. This may occur, for example, due to various conditions, such as wind blowing on the touch panel, bending or torsion of the touch panel due to handling, or other factors. In accordance with some embodiments, the touch sensing system may use pre-touch information to confirm that a valid touch has occurred. Such an implementation is illustrated by the flowchart of FIG. 3A. Initially, the system senses for 310 a touch implement hovering above the touch panel and touch on the touch panel. If a touch is detected 320, the system checks 330 to see if a hovering implement (pre-touch) was previously detected. If the hovering implement was previously detected 330, the system determines that the touch is valid 350 and calculates 355 touch location. The touch location calculation may use pre-touch location information to increase the speed, increase the accuracy, and/or decrease the processing complexity of the final touch location computation as described herein. If the hovering implement was not previously detected 330, then the touch may be determined to be a false touch and touch location is not calculated 340, or additional measurements may be done to confirm a valid touch, or a higher signal threshold may be required to confirm a valid touch.

According to some embodiments, the touch sensing system has the capability of measuring Z-axis information including both pre-touch distance from the touch surface prior to the touch implement making contact with the touch panel and touch force on the touch panel after contact. In these embodiments, touch down and/or lift off may detected, for example, when the Z-axis component is consistent with a Z-axis touch down and/or lift off criterion. FIG. 3B is a flowchart illustrating this implementation.

The Z-axis component of the touch is measured 360, including both pre-touch distance from the touch surface and touch force on the touch surface. In one implementation, pre-touch distance may be measured using one sensor type and touch force may be measured using a second sensor type. If the Z-axis component is consistent 370 with a touch down criterion, then the touch is detected 380. The touch criterion may be selectable from a range including a distance from the touch surface to an amount of force applied to the touch surface. After touch down is detected 380, the X,Y touch location is determined 390. In some implementations, X,Y touch location determination may make use of both pre-touch down and post-touch down information as described herein.

Additionally, the rate of change of the Z-axis component may be used as a touch down criterion, or to modify other touch down criteria. For example, pre-touch Z may increase rapidly, indicating an approaching touch implement. The rate of change of pre-touch Z will typically change from positive to negative at the moment of touch down, and the rate of change of applied force will increase rapidly at the same moment of touch down. A deviation from this typical touch profile may indicate a false touch or that additional testing is required to confirm a valid touch down. A rapid change in force not preceded by a pre-touch Z increase may indicate a (non-touch) acoustic wave has impacted the touch screen surface, or that the touch panel system has undergone a non-touch acceleration such as a tap to the bezel or shaking of the display system.

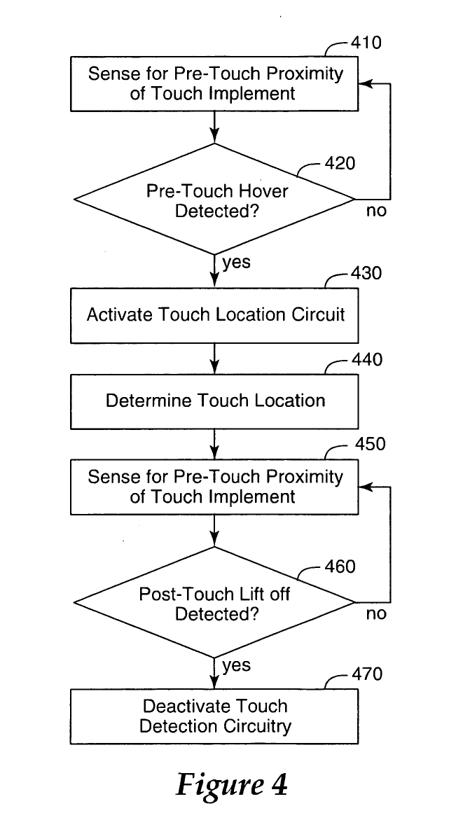

A touch or pre-touch sensing system in accordance with embodiments of the invention may be used to activate touch detection circuitry prior to touch down and/or may be used to deactivate touch detection circuitry after touch liftoff. Activating the touch location circuitry only when it is needed to detect the touch and/or to determine the touch location conserves device power. The flowchart of FIG. 4 illustrates a method of activating and deactivating touch location circuitry. In accordance with this embodiment, the system senses for 410 a hovering touch implement and may determine the proximity of the hovering touch implement from the touch surface. The system powers up 430 the touch location circuitry after sensing 420 the hovering implement. For example, in one implementation, the touch sensing and/or touch location circuitry may be activated immediately upon detecting the hovering implement, for example by measuring a pre-touch signal(s) exceeding a preset threshold, and/or the rate of change of a pre-touch signal exceeding a preset threshold. In another implementation, the touch sensing and/or touch location circuitry may be activated when the touch implement is within a predetermined distance from the touch surface.

The location of the touch may be determined 440 based on signals from the touch sensors using the activated touch location circuitry. In some implementations, the pre-touch location may also be used in touch location determination. The system senses for 450 lift off of the touch implement from the touch panel using the pre-touch sensors. Lift off may be detected, for example, when the touch implement exerts minimal force on the touch panel or when the touch implement is measured to be a predetermined distance from the surface of the touch panel, or when the rate of change of pre-touch signals exceeds a threshold. Following lift off detection 460, the touch location circuits are deactivated 470 to conserver power.

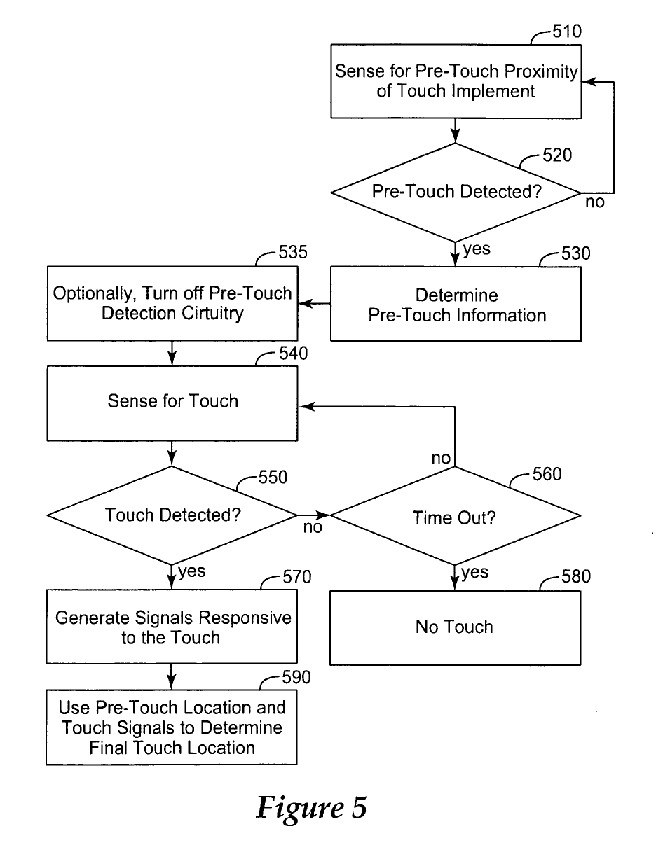

In some embodiments, the pre-touch sensors may be deactivated after detecting a hovering touch implement and/or determining the pre-touch location. This embodiment is illustrated in the flowchart of FIG. 5. The system senses for 510 a hovering touch implement. If a pre-touch condition is detected 520, the pre-touch location is determined 530. In one implementation, the pre-touch location may be computed when the touch implement is a predetermined distance from the touch surface. In another implementation, the pre-touch location may be computed when the pre-touch signals exceed a threshold. The circuitry used to sense for a pre-touch condition and to determine the pre-touch location may be deactivated after the pre-touch location is computed.

The system senses for 540 touch down. If no touch occurs 550 for a period of time 560, then the system determines that a valid touch did not occur 580. When a touch occurs 550, the touch sensors generate 570 signals responsive to the touch. The touch signals and the pre-touch location are used to determine 590 the touch location. If the pre-touch sensing circuitry and/or the pre-touch location circuitry was deactivated, it may be reinitialized after lift off detection.

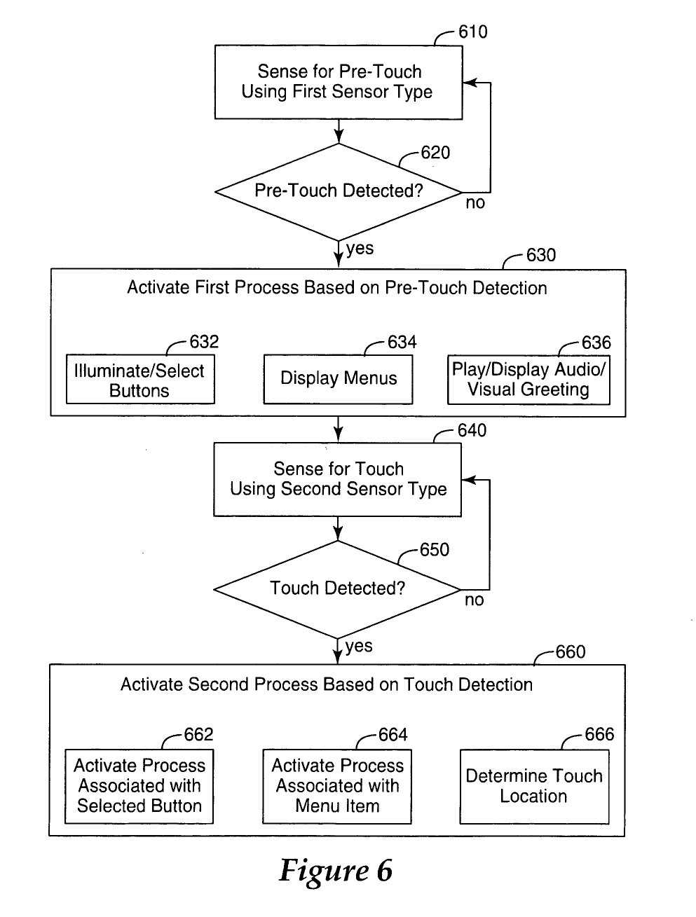

In some embodiments of the invention, detection of a hovering touch implement may be used to activate a first set of processes and touch detection may be used to activate a second set of processes. In the example illustrated in FIG. 6, hover detection and touch detection are implemented using different types of touch sensors. The system senses for 610 a hovering implement using a first sensor type or methodology. If a hovering implement is detected 620, then one or more of a first set of processes may be activated 630. Block 630 illustrates some of the processes that may be activated by the hover detection. The processes may include, for example, displaying and/or selecting an image, such as a map, displaying and/or selecting of one or more icons on a touch panel display, making visible, magnifying, illuminating or selecting certain buttons, menus, and/or areas on a touch panel display 632, 634, moving a cursor based on the pre-touch location, activating 636 an audio and/or visual greeting, and/or other processes. The buttons, menus, images, display areas and/or icons activated by the hover detection may be normally hidden and/or non-illuminated, or always visible and/or illuminated, for example.

The system senses for 640 a touch using a second type of sensor. If a touch is detected 650, one or more of a second set of processes may be activated 660 based on the touch detection. The processes triggered by the touch detection 650 may include, for example, activating of a one or more processes associated with a menu or button selected by the hover location 662, 664, determining the touch location 666, and/or other processes. In one implementation, a menu may be pulled down by the hovering touch implement. A menu item may be selected when touched. Methods described in U.S. patent application Publication 2003/0067447, which is incorporated herein by reference, may be used to invoke a menu that is unique to a specific user who is hovering. For example, a car driver may invoke a different menu than a menu invoked by a passenger in the car. In a further application, a potential user who comes into range of the touch panel may be greeted by an audio and/or video sequence to attract the user to interact with the system.

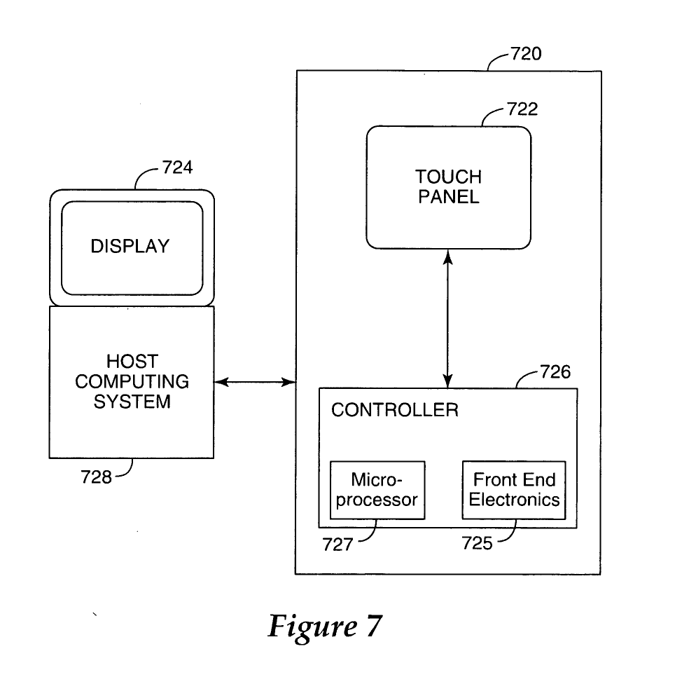

Turning now to FIG. 7, there is shown an embodiment of a touch panel system that is suitable for utilizing pre-touch sensing in accordance with embodiments of the present invention. The touch system shown in FIG. 7 includes a touch panel 722, which is communicatively coupled to a controller 726. The controller 726 includes at least electronic circuitry 725 (e.g., i.e., drive/sense front end electronics) that applies signals to the touch panel 722 and senses pre-touch touch signals and touch signals. In more robust configurations, the controller 726 can further include a microprocessor 727 in addition to front end electronics 725. In a typical deployment configuration, the touch panel 722 is used in combination with a display 724 of a host computing system 728 to provide for visual and tactile interaction between a user and the host computing system 728.

It is understood that the touch panel 722 can be implemented as a device separate from, but operative with, a display 724 of the host computing system 728. Alternatively, the touch panel 722 can be implemented as part of a unitary system that includes a display device, such as a plasma, LCD, or other type of display technology amenable to incorporation of the touch panel 722. It is further understood that utility is found in a system defined to include only the touch panel 722 and controller 726 which, together, can implement touch methodologies of the present invention.

In the illustrative configuration shown in FIG. 7, communication between the touch panel 722 and the host computing system 728 is effected via the controller 726. It is noted that one or more controllers 726 can be communicatively coupled to one or more touch panels 722 and the host computing system 728. The controller 726 is typically configured to execute firmware/software that provides for detection of touches applied to the touch panel 722, including acquiring and using pre-touch information in accordance with the principles of the present invention. It is understood that the functions and routines executed by the controller 726 can alternatively be effected by a processor or controller of the host computing system 728.

In some implementations, the controller 726 and/or host computing system 728 may use pre-touch and/or touch signals to activate one or more processes as described herein. In some embodiments, the host computing system 728 may activate one or more processes based on the touch state. For example, the touch state may be reported to the host computing system 728 in terms of pre-touch proximity (Z-axis distance) of the touch implement, pre-touch (X,Y) location, Z-axis force on the touch panel and/or touch (X,Y) location. During a pre-touch state, the host computing system 728 may activate one or more of a first set of processes. The host computing system 728 may activate one or more of a second set of processes after touch down.

In one implementation, the pre-touch signals may be used to operate a cursor visible on the display 724, for example, the cursor may track the pre-touch location. Button icons on the display may be activated, illuminated and/or selected based on pre-touch location and proximity of the touch implement. The pre-touch signals may be used activate pull down menus and select items from the menus and/or play or display an audio and/or visual message.

The host computing system 728 may activate one or more of a second set of processes following detection of touch down of the touch implement on the touch panel 722. In various embodiments, touch down detection and/or touch location information may be used to activate a process associated with a menu item or button selected or highlighted by a process activated by a pre-touch condition.

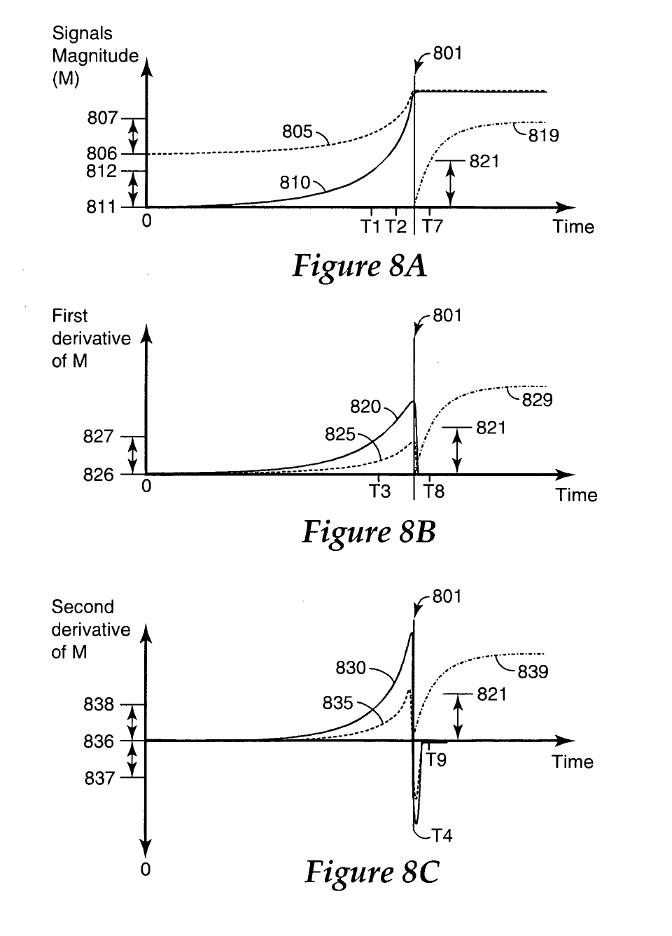

FIGS. 8A-8C show graphs of signal vs. time associated with two touch down events. Pre-touch signals are measured by an analog capacitive method. Touch down is measured using capacitive signals and also by a force based touch method. Time 801 indicates the time of touch down.

In FIG. 8A, graphs 805, 810 illustrate two types of pre-touch conditions. Signal 810 represents capacitive signal magnitude generated by a touch that rapidly approaches the touch surface from a large distance, and moves steadily until it impacts the touch surface at time 801. Signal 810 flattens after touch down, and force signal 819 increases from zero at touch down exceeding the touch force threshold level 821 at T7. Capacitive touch is often detected as a rapid level change exceeding a threshold, represented by the difference in magnitude between base level 811 and touch threshold 812. Signal 810 exceeds threshold 812 at time T1.

Signal 805 shows a different pre-touch condition where a touching implement hovers above a touch surface for a sufficient time that the capacitive touch threshold base level 806 is adjusted to equal signal 805 level, and threshold 807 is adjusted correspondingly. Signal 805 still exceeds threshold 807 at time T2. One example of long-duration hover is in gaming systems where players remain poised close to a touch surface so they may quickly touch icons that flash on a display.

Curves 820 and 825 of FIG. 8B are first derivatives of signals 810 and 805 respectively. The peak levels of 820 and 825 may be used to detect touch down, for example if curve 820 or 825 exceeds threshold 827 at time T3, a touch down may be determined. The base level adjustment method shown in graph 800 may not be applied to the first derivatives situation. Thus the threshold is not adjusted to compensate for the long-duration hover situation described above, and the touch corresponding to curve 825 may not be detected by the first derivative method. Force signal 829 increases from zero at touch down, exceeding force threshold 821 at T8 so the force measurement may detect a touch that is not detected by capacitive methods.

Curves 835 and 830 of FIG. 8C are the second derivatives of curves 805 and 810 respectively. As with the first derivative, adjustment of base 836 may not be practical so threshold 837 may be fixed. Threshold 837 is at a negative level so it measures the deceleration of capacitive signals 805 or 810. A touch may be detected at T4 when the second derivative curve exceeds in a negative direction the threshold 837. A touch may also be detected using threshold 838, or the combination of exceeding thresholds 838 and 837 may be required to determine a valid touch down. In addition, signal 805 exceeding threshold 807, and/or curve 825 exceeding threshold 827, and/or force signal 839 exceeding threshold 821 at time T9 may provide additional criteria for a valid touch down.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A touch sensing method, comprising:
generating pre-touch signals responsive to a presence of a touch implement near a touch surface;
generating touch signals responsive to a touch on the touch surface from the touch implement; and
determining a location of the touch on the touch surface based on the touch signals and the pre-touch signals.

2. The method of claim 1, further comprising determining a pre-touch location of the touch implement relative to the touch surface based on the pre-touch signals, wherein determining the location of the touch on the touch surface comprises determining the location based on the pre-touch location.

3. The method of claim 2, wherein determining the pre-touch location comprises determining X and Y-axis coordinates of the pre-touch location relative to a plane of the touch surface.

4. The method of claim 2, further comprising determining a Z-axis component of at least one of the pre-touch location and the touch location.

5. The method of claim 4, wherein determining the Z-axis component comprises measuring a distance of the touch implement from the touch surface.

6. The method of claim 4, wherein determining the Z-axis component comprises measuring a touch force.

7. The method of claim 1, further comprising detecting the touch if the touch implement is at least one of closer than a predetermined distance from the touch surface and producing a force on the touch surface larger than a predetermined force.

8. The method of claim 1, wherein:
generating the pre-touch signals comprises generating the pre-touch signals using one or more of a first type of sensor; and
generating the touch signals responsive to the touch comprises generating the touch signals using one or more of a second type of sensor.

9. The method of claim 1, further comprising:
activating a first process based on the pre-touch signals; and
activating a second process based on the touch signals.

10. The method of claim 1, further comprising activating touch location circuitry based on the pre-touch signals.

11. The method of claim 1, further comprising deactivating pre-touch location circuitry based on the touch signals.

12. A touch sensitive device, comprising:
a touch surface;
one or more pre-touch sensors configured to generate pre-touch signals responsive to a touch implement near the touch surface, the pre-touch signals indicative of a pre-touch location of the touch implement;
one or more touch sensors configured generate touch signals responsive to a touch by the touch implement on the touch surface, the touch signals indicative of a touch location of the touch implement; and
a controller configured to determine the touch location based on the pre-touch signals and the touch signals.

13. The device of claim 12, wherein the one or more pre-touch sensors comprise a different type of sensor than the one or more touch sensors.

14. The device of claim 12, wherein the one or more pre-touch sensors comprise the same type of sensor as the one or more touch sensors.

15. The device of claim 12, wherein the controller is configured to detect at least one of touch down and lift off of the touch implement on the touch surface using at least one of the pre-touch signals and the touch signals.

16. The device of claim 12, wherein the controller is configured to detect at least one of touch down and lift off based on a distance of the touch implement from the touch surface.

17. The device of claim 12, wherein the controller is configured to detect at least one of touch down and lift off based on a force exerted by the touch implement on the touch surface.

18. The device of claim 12, wherein the controller is configured to activate one or more processes based on at least one of the touch signals and the pre-touch signals.

19. The device of claim 12, wherein the controller is configured to detect a false touch based on the pre-touch signals.

20. The device of claim 12, further comprising:
a display visible through the touch surface; and
a host computing system coupled to the display and the controller, the host computing system configured to control the display based on a touch state.

21. The device of claim 20, wherein the host computing system is configured to control movement of a cursor displayed on the display based on the touch state.

22. The device of claim 20, wherein the host computing system is configured to activate display of an image on the display based on the touch state.

23. The device of claim 20, wherein the host computing system is configured to activate one or more of a first set of processes based on at least one of pre-touch location and pre-touch proximity of the touch implement and to activate one or more of a second set of processes based on at least one of a touch location and a touch force.

24. A touch sensitive device, comprising:
means for generating pre-touch signals responsive to a presence of a touch implement near a touch surface;
means for generating touch signals responsive to a touch by the touch implement on the touch surface; and
means for determining a location of a touch on the touch surface based on the touch signals and the pre-touch signals.

25. The touch sensitive device of claim 23, further comprising means for determining a Z-axis component of at least one of a pre-touch location and the touch location.

26. The touch sensitive device of claim 23, further comprising:
means for activating a first process based on the pre-touch signals; and
means for activating a second process based on the touch signals.
